(19) United States
(12) Patent Application Publication
(10) Pub. No.: US 2026/0285200 A1
(43) Pub. Date: Sep. 24, 2026

(54) SEAT CUSHION TILTING DEVICE

(71) Applicants: Hyundai Motor Company, Seoul (KR); Kia Corporation, Seoul (KR); Hyundai Transys Inc., Seosan-si (KR)

(72) Inventors: Sang Hark LEE, Hwaseong-Si (KR); Eun Sue KIM, Hwaseong-Si (KR); Soo Bok KIM, Hwaseong-Si (KR); Ji Yun HA, Hwaseong-Si (KR); Ui Jeong LEE, Hwaseong-Si (KR); Gu Chang KANG, Hwaseong-Si (KR); Hyun Seok SONG, Hwaseong-Si (KR)

(73) Assignees: Hyundai Motor Company, Seoul (KR); Kia Corporation, Seoul (KR); Hyundai Transys Inc., Seosan-si (KR)

(21) Appl. No.: 19/304,303

(22) Filed: Aug. 19, 2025

(30) Foreign Application Priority Data
Mar. 19, 2025 (KR) 10-2025-0035370

(51) Int. Cl. B60N 2/02

(52) U.S. Cl. CPC B60N 2/02; B60N 2002/0216

(57) ABSTRACT

A seat cushion tilting device includes a cushion upper frame disposed to be tiltable relative to a cushion lower frame, a hinge pipe fixed to the cushion lower frame, a tilting bracket disposed to be rotatable about the hinge pipe and configured to tilt the cushion upper frame, a tilting bladder configured to receive fluid to rotate the tilting bracket, and a fluid locking device configured to receive the fluid to switch a rotational state of the tilting bracket relative to the hinge pipe.

### CROSS-REFERENCE TO RELATED APPLICATIONS

The present application claims priority from Korean Patent Application No. 10-2025-0035370, filed on Mar. 19, 2025, in the Korean Intellectual Property Office, the disclosure of which is incorporated herein by reference in its entirety.

### BACKGROUND OF THE PRESENT DISCLOSURE

The present disclosure relates to a technique for tilting a cushion of a seat mounted in a vehicle or the like.

Some vehicles have a function of tilting a vehicle seat to support the passenger’s thigh. Recently, to achieve improvement in fuel efficiency of electric vehicles, vehicles employ a pneumatic tilting mechanism instead of a tilting mechanism using a conventional motor.

As described above, a cushion tilting mechanism using pneumatic pressure may reduce the weight and cost of a vehicle. Meanwhile, when the tilting angle is fixed by constantly maintaining air pressure inside a bladder, the amount of bladder inflation may vary depending on seated passengers due to compressibility of the air. Additionally, in the instant case, it is impossible to accurately maintain the tilting angle at a set height.

The information included in the present Background of the Disclosure section is only for enhancement of understanding of the general background of the disclosure, and should not be taken as an acknowledgement or any form of suggestion that this information forms the prior art already known to a person skilled in the art.

Therefore, the present disclosure has been made in view of the above problems, and in various aspects of the present disclosure, is directed to providing a seat cushion tilting device configured to reduce the weight and cost of a vehicle by implementing a seat tilting function using fluid.

In various aspects of the present disclosure, the present disclosure is directed to providing a seat cushion tilting device configured to accurately and stably fix the cushion tilting angle adjusted to a level desired by a passenger, improving ride comfort of a vehicle and ultimately enhancing marketability of the vehicle.

The aspects of the present disclosure are not limited to the above-mentioned aspects, and other technical aspects not mentioned herein will be clearly understood by those skilled in the art to which the present disclosure pertains from the detailed description of the embodiments.

In various aspects of the present disclosure, the above and other aspects may be accomplished by the provision of a seat cushion tilting device including a cushion upper frame disposed to be tiltable relative to a cushion lower frame, a hinge pipe fixed to the cushion lower frame, a tilting bracket disposed to be rotatable about the hinge pipe and configured to tilt the cushion upper frame, a tilting bladder configured to receive fluid to rotate the tilting bracket, and a fluid locking device configured to receive the fluid to switch a rotational state of the tilting bracket relative to the hinge pipe.

In various aspects of the present disclosure, the fluid locking device and the tilting bladder may be configured to receive the fluid from the same fluid supply source.

In various aspects of the present disclosure, the tilting bracket may include a hinge block surrounding the hinge pipe in a relatively rotatable state, a rear lever plate connected to a rear side of the hinge block, the rear lever plate being disposed to be pressed by the tilting bladder, and a front lever plate connected to a front side of the hinge block, the front lever plate being pressed by the tilting bladder and being configured to tilt the cushion upper frame.

In various aspects of the present disclosure, the fluid locking device may include a tube bladder inserted into the hinge pipe, the tube bladder being configured to expand in diameter thereof when the fluid is injected thereinto, a flexible gear disposed on an external circumferential surface of the tube bladder to be exposed to an outside of the hinge pipe, and a block internal gear disposed on an internal circumferential surface of the hinge block, the block internal gear being configured for the flexible gear to be engaged therewith when the diameter of the tube bladder is expanded.

In various aspects of the present disclosure, the tube bladder may include a fixing protrusion disposed on the external circumferential surface thereof, the fixing protrusion being inserted into an internal circumferential surface of the hinge pipe to prevent rotation of the tube bladder relative to the hinge pipe.

In various aspects of the present disclosure, the hinge pipe may be formed of a plurality of disconnected hinge pipe segments spaced apart from each other and disposed in a straight line within the hinge block, enabling the flexible gear to be engaged with the block internal gear.

In various aspects of the present disclosure, the tilting bladder may be formed of a rear bladder disposed on a rear side of the hinge pipe and a front bladder disposed on a front side of the hinge pipe, and the seat cushion tilting device may further include a rear support plate fixed to the rear side of the hinge pipe, the rear support plate being configured to support, from an upper side of the rear bladder, the rear bladder pressing the rear lever plate, and a front support plate fixed to the front side of the hinge pipe, the front support plate being configured to support, from a lower side of the front bladder, the front bladder pressing the front lever plate.

In various aspects of the present disclosure, the fluid locking device may include a fixed pole disposed on the hinge block and configured to be movable toward the hinge pipe, a pipe external gear formed on an external circumferential surface of the hinge pipe and configured to be engaged with the fixed pole, and a pole driving bladder elastically deformed by the fluid injected thereinto so that the fixed pole is engaged with the pipe external gear.

In various aspects of the present disclosure, the seat cushion tilting device may further include a return spring configured to apply elastic force in a direction allowing the fixed pole to be spaced apart from the pipe external gear.

In various aspects of the present disclosure, a tilting control valve configured to supply or discharge the fluid to or from the tilting bladder may be disposed between the fluid supply source and the tilting bladder, a locking control valve configured to supply or discharge the fluid to or from the fluid locking device may be disposed between the fluid supply source and the fluid locking device, and the tilting control valve and the locking control valve may be configured to be controlled by a controller.

In various aspects of the present disclosure, the controller may be configured to control, based on an input operation received from a user for adjustment of a tilting angle of a seat cushion, the locking control valve to release a locked state of the fluid locking device so that the tilting bracket is switched to a state in which the tilting bracket is rotatable about the hinge pipe, and to control, after the switching of the tilting bracket, the tilting control valve in response to an operation from the user to supply or discharge the fluid to or from the tilting bladder, and the controller may be configured to control, based on determination that the operation received from the user is completed, the locking control valve to form the locked state of the fluid locking device so that the tilting bracket is restricted from being rotated around the hinge pipe.

In various aspects of the present disclosure, the controller may be provided to communicate with a vehicle collision warning system, and the controller may be configured to release the locked state of the fluid locking device based on a vehicle collision possibility determined by the vehicle collision warning system, and to supply the fluid to the tilting bladder to increase the tilting angle of a front side of the seat cushion.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a view showing a seat cushion tilting device according to an exemplary embodiment of the present disclosure;

FIG. 2 is a view showing the assembled state of main components in FIG. 1;

FIG. 3 is an exploded view of the main components in FIGS. 1 and 2;

FIG. 4 is a view showing the tilting principle of a tilting bracket;

FIG. 5 is a view showing the scissors-shaped arrangement of the tilting bracket, a front support plate, and a rear support plate;

FIG. 6A and FIG. 6B are views showing a state in which an engagement state between a flexible gear and a block internal gear is switched by a change in diameter of the flexible gear;

FIG. 7 is a view conceptually showing another embodiment of a fluid locking device; and

FIG. 8 is a view showing a circuit configured to supply fluid to a tilting bladder and a tube bladder or a pole driving bladder of the fluid locking device.

### DETAILED DESCRIPTION

In describing the embodiments disclosed herein, when it is determined that a detailed description of related publicly known techniques may obscure the gist of the embodiments disclosed in this specification, the detailed description thereof will be omitted. Furthermore, it should be understood that the accompanying drawings are merely illustrated to easily describe the embodiments disclosed in this specification, and therefore, the technical idea disclosed in this specification is not limited by the accompanying drawings. Furthermore, it should be noted that the accompanying drawings include all modifications, equivalents, and substitutes that fall within the spirit and technical scope of the present disclosure.

Meanwhile, in the present disclosure, terms such as "first" and/or "second" may be used to describe various components, but the components are not limited by the terms. The terms are used only for distinguishing one component from other components.

In the present specification, an expression in a singular form also includes the plural sense, unless clearly specified otherwise in context.

It should be understood that expressions such as "comprise" and "have" in the present specification are intended to designate the presence of indicated features, numbers, steps, operations, components, parts, or combinations thereof, but do not exclude the presence or addition of one or more features, numbers, steps, operations, components, parts, or combinations thereof.

Hereinafter, the suffixes "module", "unit", and "part" for components used in the following description are merely provided for facilitation of preparing the present specification. Therefore, the suffixes themselves do not have significant meanings or roles.

When one component is referred to as being "connected" or "coupled" to another component, the one component may be directly connected or coupled to the other component, but it should be understood that other components may be present therebetween. On the other hand, when the one component is referred to as being "directly connected" or "directly coupled" to the other component, it should be understood that no other components are present therebetween.

Any number of components or a variety of components in any of the configurations described herein may be included in the present disclosure. The components may include any combination of the features described herein, and may be disposed in any of the various configurations described herein. The structure and arrangement of components of the present disclosure, as well as the concepts regarding the use and operation of the components, may be applied not only to the specific embodiments discussed herein, but also to any number of embodiments in any combination. Embodiments including those having various features in various arrangements are described below with reference to the drawings.

Hereinafter, various embodiments included herein will be described in detail with reference to accompanying drawings, and regardless of the drawing symbols, the same or similar components will be denoted by the same reference numerals, and redundant descriptions thereof will be omitted.

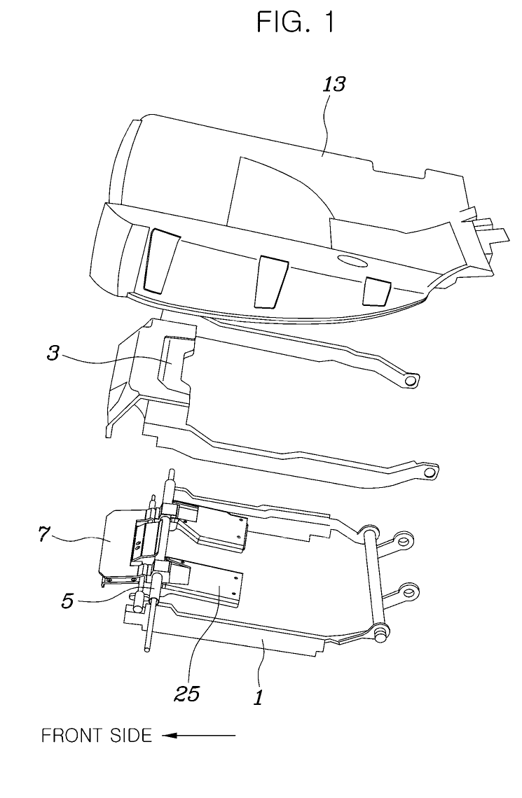

Referring to FIGS. 1 to 6, a seat cushion tilting device according to an exemplary embodiment of the present disclosure includes a cushion upper frame 3 disposed to be tiltable relative to a cushion lower frame 1, a hinge pipe 5 fixed to the cushion lower frame 1, a tilting bracket 7 disposed to be rotatable about the hinge pipe 5 and configured to tilt the cushion upper frame 3, a tilting bladder 9 configured to receive fluid to rotate the tilting bracket 7, and a fluid locking device configured to receive fluid to switch a rotational state of the tilting bracket 7 relative to the hinge pipe 5.

That is, according to an exemplary embodiment of the present disclosure, when the fluid is supplied to the tilting bladder 9 to inflate the tilting bladder 9, the tilting bracket 7 is rotated around the hinge pipe 5 to tilt the cushion upper frame 3, and the fluid locking device may fix the tilting state formed as described above.

Here, the fluid means a compressible fluid such as air, but the present disclosure is not limited thereto. Incompressible fluid such as oil may be used.

The fluid locking device and the tilting bladder 9 are configured to receive fluid from the same fluid supply source 11.

Here, the fluid supply source 11 may be a pneumatic pump or a compression tank connected thereto to store compressed air therein.

As a result, since driving of the tilting bladder 9 to tilt the cushion upper frame 3 and driving of the fluid locking device to fix the tilting state of the cushion upper frame 3 are performed by the same fluid supply source 11, the number of parts used in the seat may be minimized, reducing the weight of the vehicle and ultimately reducing manufacturing costs.

Furthermore, the above-described fluid locking device restricts or enables rotation of the tilting bracket 7 configured to tilt the cushion upper frame 3 around the hinge pipe 5. Accordingly, when a seat cushion is tilted, the tilting bracket 7 is allowed to rotate so that a passenger easily adjusts the tilting angle of the seat cushion to a desired degree of angle, and when the tilting angle is completely adjusted, rotation of the tilting bracket 7 is restricted to accurately and stably fix the adjusted tilting state, improving ride comfort of the vehicle. Ultimately, marketability of the vehicle may be significantly enhanced.

Referring to FIG. 1, the tilting angle of the cushion upper frame 3 is configured to be adjusted through upward and downward rotation of the front side of the cushion upper frame 3 relative to the cushion lower frame 1. Furthermore, since a cushion cover 13 is coupled to the upper side of the cushion upper frame 3, the cushion cover 13 is also tilted when the cushion upper frame 3 is tilted.

Here, a separate foam member or the like may be disposed on the upper side of the cushion cover 13 to form a seat cushion.

The tilting bracket 7 includes a hinge block 15 configured to surround the hinge pipe 5 in a relatively rotatable state, a rear lever plate 17 connected to the rear side of the hinge block 15 and disposed to be pressed by the tilting bladder 9, and a front lever plate 19 connected to the front side of the hinge block 15, pressed by the tilting bladder 9, and configured to tilt the cushion upper frame 3.

Here, the tilting bladder 9 is formed of a rear bladder 21 disposed on the rear side of the hinge pipe 5 and a front bladder 23 disposed on the front side of the hinge pipe 5.

Furthermore, the seat cushion tilting device further includes a rear support plate 25 fixed to the rear side of the hinge pipe 5 and configured to support, from the upper side of the rear bladder 21, the rear bladder 21 pressing the rear lever plate 17, and a front support plate 27 fixed to the front side of the hinge pipe 5 and configured to support, from the lower side of the front bladder 23, the front bladder 23 pressing the front lever plate 19.

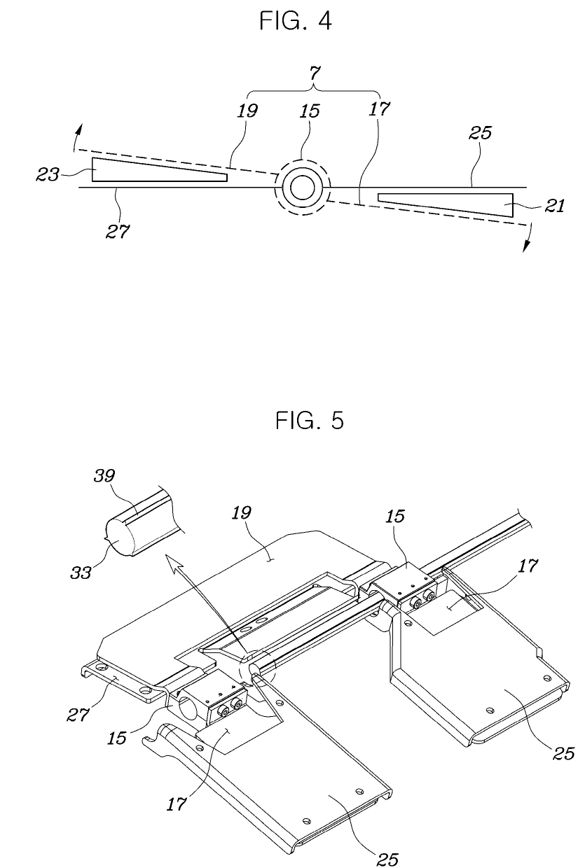

FIG. 4 is a view for description of the tilting principle by rotation of the tilting bracket 7 on a plane perpendicular to the longitudinal direction of the hinge pipe 5. Here, the front support plate 27 and the rear support plate 25 are in a state of being respectively fixed to the front side and the rear side of the hinge pipe 5 and respectively supporting one side surface of the front bladder 23 and one side surface of the rear bladder 21. In the instant state, according to the tilting principle of the tilting bracket 7 indicated by dotted lines, the rear lever plate 17 is pressed downwards by inflation of the rear bladder 21, and the front lever plate 19 is pressed upwards by inflation of the front bladder 23, increasing the tilting angle in conjunction with clockwise rotation.

Meanwhile, when the fluid supplied to each of the front bladder 23 and the rear bladder 21 is discharged, the front bladder 23 and the rear bladder 21 are deflated, and the tilting bracket 7 is rotated counterclockwise by gravity, reducing the tilting angle.

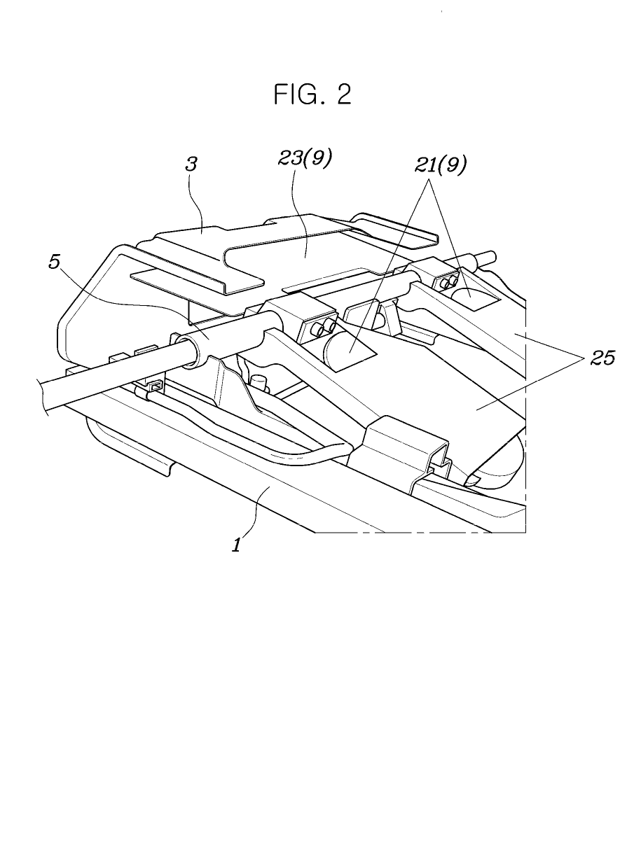

For reference, FIG. 2 shows an assembled state in which some components of the cushion cover 13 and the cushion upper frame 3 are omitted, and the front lever plate 19 is also omitted in the assembled state.

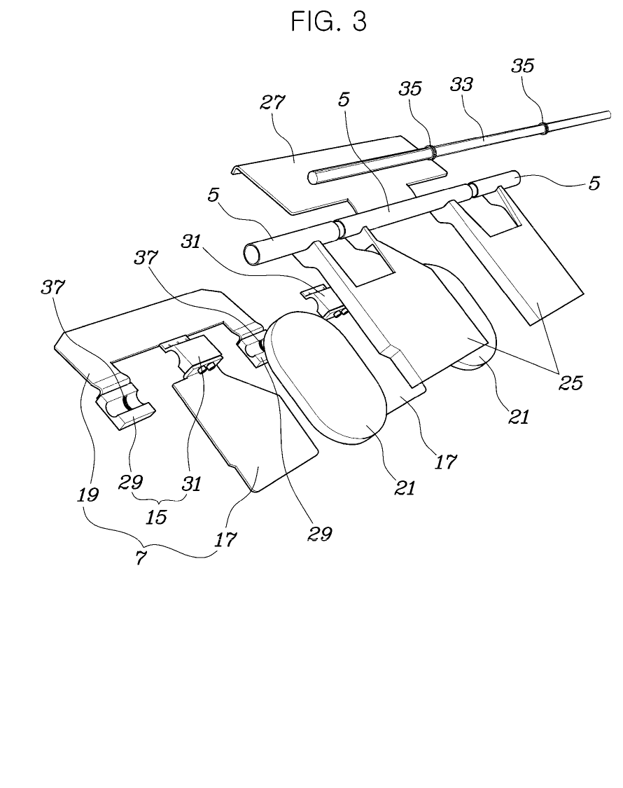

In FIG. 3, the hinge block 15 includes a lower block 29 and an upper block 31. The front lever plate 19 is integrally connected to the lower block 29, and the rear lever plate 17 is integrally connected to the upper block 31, allowing the lower block 29 and the upper block 31 to be coupled to each other with the hinge pipe 5 interposed therebetween. Through the above-described structural configuration, the front lever plate 19 and the rear lever plate 17 are rotatable about the hinge pipe 5 provided as a rotation axis.

FIG. 5 is a view showing a state in which the lower block 29 and the upper block 31 are coupled to each other to form the hinge block 15. Here, in the instant state in the instant state, the front lever plate 19 is disposed on the upper side of the front support plate 27, and the rear lever plate 17 is disposed on the lower side of the rear support plate 25, forming a scissors-shaped arrangement, as shown in FIG. 4.

For reference, the hinge pipe 5 is omitted in FIG. 5, and only a tube bladder 33 to described later is shown.

Meanwhile, the fluid locking device includes the tube bladder 33 inserted into the hinge pipe 5 and configured to expand in diameter thereof when fluid is injected thereinto, a flexible gear 35 disposed on the external circumferential surface of the tube bladder 33 to be exposed to the outside of the hinge pipe 5, and a block internal gear 37 disposed on the internal circumferential surface of the hinge block 15 to allow the flexible gear 35 to be engaged with the block internal gear 37 when the diameter of the tube bladder 33 is expanded.

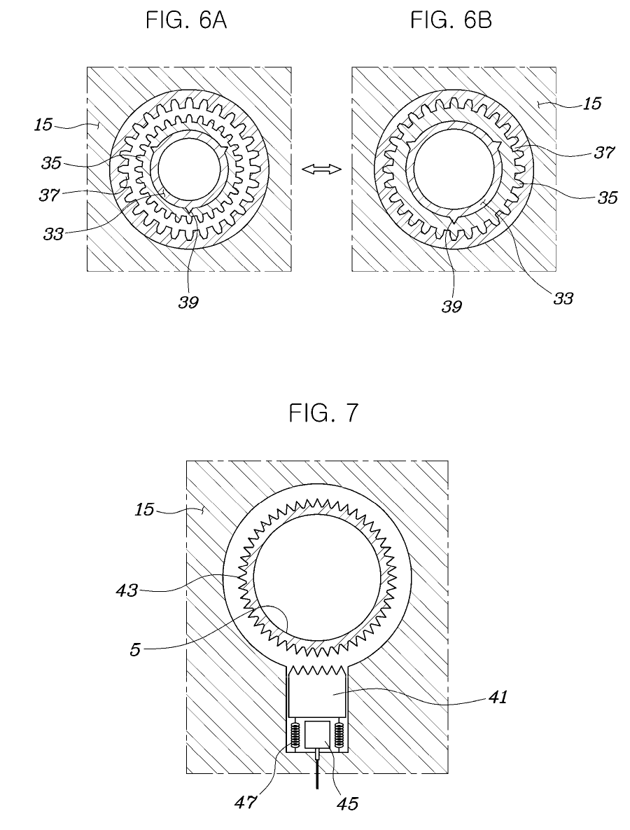

That is, similarly to the tilting bladder 9, the tube bladder 33 includes a material which is elastically expandable and contractable. Accordingly, when fluid is supplied to the tube bladder 33 so that the tube bladder 33 is inflated, as shown in FIG. 6A and FIG. 6B, the external diameter of the flexible gear 35 is expanded, and the flexible gear 35 is engaged with the block internal gear 37, restricting rotation of the hinge block 15 around the hinge pipe 5.

Therefore, the tilting bracket 7 is restricted from being rotated around the hinge pipe 5, and even if the tilting bladder 9 is inflated or deflated for various reasons such as temperature change, the tilting state of the cushion upper frame 3 may be stably maintained in a constant state.

To more securely fix the tilting state described above, preferably, the external surface of the tube bladder 33 includes a fixing protrusion 39 provided thereon and inserted into the internal circumferential surface of the hinge pipe 5 to prevent rotation of the tube bladder 33 relative to the hinge pipe 5.

Here, the hinge pipe 5 is formed of a plurality of disconnected hinge pipe segments spaced apart from each other and aligned in a straight line within the hinge block 15, allowing the flexible gear 35 to be engaged with the block internal gear 37.

That is, when the flexible gear 35 is engaged with the block internal gear 37 of the hinge block 15 surrounding the hinge pipe 5 through inflation of the tube bladder 33 inserted into the hinge pipe 5, the corresponding segment of the hinge pipe 5 should be absent at a portion where the flexible gear 35 and the block internal gear 37 are located. For the present reason, the hinge pipe 5 includes the plurality of disconnected hinge pipe segments.

In the instant case, since the hinge pipe 5 is configured as the rotation axis of the hinge block 15, the disconnected hinge pipe segments need to be fixed in a state of forming a single straight line as described above. Additionally, according to the structural configuration of the hinge pipe 5 of the exemplary embodiment, the opposite disconnected hinge pipe segments are directly fixed to the cushion lower frame 1, and the central disconnected hinge pipe segment is fixed to the cushion lower frame 1 through a separate member.

Meanwhile, the fluid locking device may be configured as follows.

That is, as shown in FIG. 7, the fluid locking device includes a fixed pole 41 disposed on the hinge block 15 and configured to be movable toward the hinge pipe 5, a pipe external gear 43 formed on the external circumferential surface of the hinge pipe 5 and configured to be engaged with the fixed pole 41, and a pole driving bladder 45 elastically deformed by fluid injected thereinto so that the fixed pole 41 is engaged with the pipe external gear 43.

Therefore, when the fluid is supplied to the pole driving bladder 45 so that the pole driving bladder 45 is inflated, the fixed pole 41 is moved upwards to be engaged with the pipe external gear 43 formed on the hinge pipe 5, restricting rotation of the hinge block 15 around the hinge pipe 5. Accordingly, the tilting angle of the tilting bracket 7 is fixedly maintained in a constant state. Meanwhile, when the fluid is discharged from the pole driving bladder 45, the fixed pole 41 is moved downwards due to gravity and is spaced apart from the pipe external gear 43. Accordingly, the hinge block 15 becomes rotatable about the hinge pipe 5.

As described above, the fixed pole 41 may be configured to be moved downwards due to gravity to be spaced apart from the pipe external gear 43, or may be configured to be moved in conjunction with elastic contraction of the pole driving bladder 45.

Furthermore, as shown in FIG. 7, the fixed pole 41 may be provided with a return spring 47 configured to apply elastic force in a direction in which the fixed pole 41 is spaced apart from the pipe external gear 43. Accordingly, the locked state may be more reliably and stably released.

In an exemplary embodiment of the present disclosure of the fluid locking device, the hinge pipe 5 is not divided into a plurality of hinge pipes but is formed as a single straight member, and the pipe external gear 43 is integrally formed on a part of the surface of the hinge pipe 5, having an effect of more reliably securing fixing and arrangement workability of the hinge pipe 5.

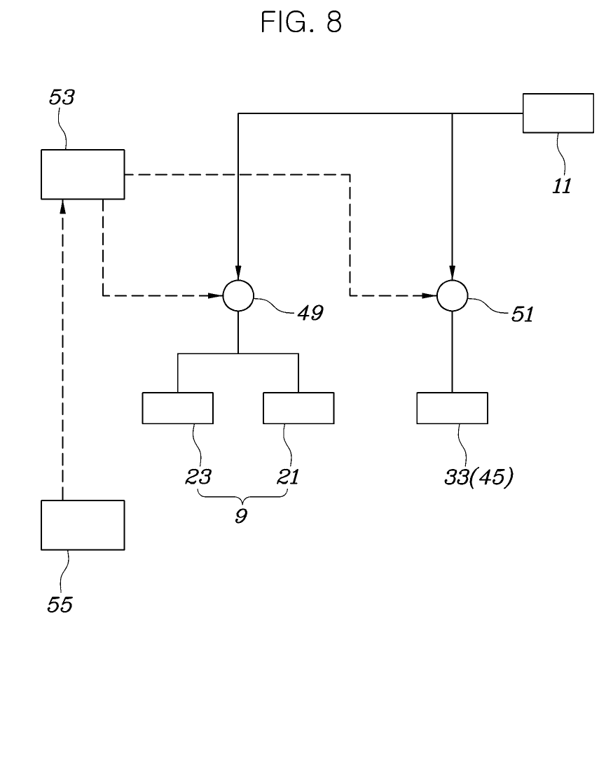

FIG. 8 is an example of a circuit configured to supply fluid to the tilting bladder 9 and the tube bladder 33 or the pole driving bladder 45 of the fluid locking device. In the present configuration, a tilting control valve 49 configured to supply or discharge fluid to or from the tilting bladder 9 is disposed between the fluid supply source 11 and the tilting bladder 9, and a locking control valve 51 configured to supply or discharge fluid to or from the fluid locking device is disposed between the fluid supply source 11 and the fluid locking device.

The tilting control valve 49 and the locking control valve 51 are configured to be controlled by a controller 53, and the controller 53 may receive an input operation from a user.

Here, the controller 53 is configured to control, based on an input operation received from a user for adjustment of the tilting angle of a seat cushion, the locking control valve 51 to release the locked state of the fluid locking device so that the tilting bracket 7 is switched to a state in which the tilting bracket 7 is rotatable about the hinge pipe 5, and to control, after the switching of the tilting bracket 7, the tilting control valve 49 in response to an operation from the user to supply or discharge the fluid to or from the tilting bladder 9.

Furthermore, the controller 53 is configured to control, based on determination that the tilting operation received from the user is completed, the locking control valve 51 to form the locked state of the fluid locking device so that the tilting bracket 7 is restricted from being rotated around the hinge pipe 5.

Of course, as described above, when the user performs the tilting operation, the controller 53 may be configured to automatically adjust the locked state of the fluid locking device through the locking control valve 51, or the user may be configured to directly adjust the locked state of the fluid locking device through a separate locking-and-releasing operation.

Meanwhile, as shown in FIG. 8, the controller 53 may be provided to communicate with a vehicle collision warning system 55.

The vehicle collision warning system 55 detects a potential collision with an object, such as another vehicle or a pedestrian, and provides a corresponding signal to the controller 53. The vehicle collision warning system 55 can be embodied in various forms.

For example, the vehicle collision warning system 55 may include, but is not limited to, a RADAR or LIDAR sensor to detect the distance and relative speed to forward objects, a camera-based system that analyzes image data to identify collision risks, or a V2X (Vehicle-to-Everything) communication module to receive warning messages from external sources like other vehicles or infrastructure.

These technologies can be used individually or in combination (e.g., through sensor fusion) to improve reliability. The warning signal is transmitted to the controller 53, for instance, via a standard vehicle communication bus, such as a CAN bus.

In the instant case, the controller 53 is configured to release the locked state of the fluid locking device based on a vehicle collision warning signal received from the vehicle collision warning system 55, and to supply fluid to the tilting bladder 9, increasing the tilting angle of the front side of the seat cushion.

Therefore, it is possible to prevent a situation in which the lower body of a passenger slides under the seat belt in the event of vehicle collision (referred to as submarining) by increasing the tilting angle of the front side of the seat cushion, contributing to improvement in collision safety performance of the vehicle.

As is apparent from the above description, the present disclosure provides a seat cushion tilting device configured for implementing a seat tilting function using fluid, making it possible not only to reduce the weight and cost of a vehicle, but also to accurately and stably fix the seat cushion tilting angle adjusted to a level desired by a passenger. Accordingly, ride comfort of the vehicle may be improved, and ultimately, marketability of the vehicle may be improved.

The effects of the present disclosure are not limited to the above-mentioned effects, and other effects not mentioned herein will be clearly understood by those skilled in the art to which the present disclosure pertains from the detailed description of the embodiments.

Although the exemplary embodiments of the present disclosure have been included for illustrative purposes, those skilled in the art will appreciate that various modifications, additions, and substitutions are possible, without departing from the scope and spirit of the disclosure as included in the accompanying claims.

What is claimed is:

1. A seat cushion tilting device comprising:
a cushion upper frame disposed to be tiltable relative to a cushion lower frame;
a hinge pipe fixed to the cushion lower frame;
a tilting bracket disposed to be rotatable about the hinge pipe and configured to tilt the cushion upper frame;
a tilting bladder configured to receive fluid to rotate the tilting bracket; and
a fluid locking device configured to receive the fluid to switch a rotational state of the tilting bracket relative to the hinge pipe.

2. The seat cushion tilting device of claim 1, wherein the fluid locking device and the tilting bladder are configured to receive the fluid from a same fluid supply source.

3. The seat cushion tilting device of claim 1, wherein the tilting bracket comprises:
a hinge block surrounding the hinge pipe in a relatively rotatable state;
a rear lever plate connected to a rear side of the hinge block, the rear lever plate being disposed to be pressed by the tilting bladder; and
a front lever plate connected to a front side of the hinge block, the front lever plate being pressed by the tilting bladder and being configured to tilt the cushion upper frame.

4. The seat cushion tilting device of claim 3, wherein the fluid locking device comprises:
a tube bladder inserted into the hinge pipe, the tube bladder being configured to expand in diameter thereof based on that the fluid is injected thereinto;
a flexible gear disposed on an external circumferential surface of the tube bladder to be exposed to an outside of the hinge pipe; and
a block internal gear disposed on an internal circumferential surface of the hinge block, the block internal gear being configured for the flexible gear to be engaged therewith based on that the diameter of the tube bladder is expanded.

5. The seat cushion tilting device of claim 4, wherein the tube bladder includes a fixing protrusion disposed on the external circumferential surface thereof, the fixing protrusion being inserted into an internal circumferential surface of the hinge pipe to prevent rotation of the tube bladder relative to the hinge pipe.

6. The seat cushion tilting device of claim 4, wherein the hinge pipe is formed of a plurality of disconnected hinge pipe segments spaced apart from each other and disposed in a straight line within the hinge block, enabling the flexible gear to be engaged with the block internal gear.

7. The seat cushion tilting device of claim 4, further comprising:
a locking control valve connected to the tube bladder of the fluid locking device and configured to supply or discharge the fluid to or from the tube bladder of the fluid locking device.

8. The seat cushion tilting device of claim 3,
wherein the tilting bladder comprises:
a rear bladder disposed on a rear side of the hinge pipe; and
a front bladder disposed on a front side of the hinge pipe, and
wherein the seat cushion tilting device further comprises:
a rear support plate fixed to the rear side of the hinge pipe, the rear support plate being configured to support, from an upper side of the rear bladder, the rear bladder pressing the rear lever plate; and
a front support plate fixed to the front side of the hinge pipe, the front support plate being configured to support, from a lower side of the front bladder, the front bladder pressing the front lever plate.

9. The seat cushion tilting device of claim 8, further comprising:
a tilting control valve connected to the rear bladder and the front bladder and configured to supply or discharge the fluid to or from the rear bladder and the front bladder.

10. The seat cushion tilting device of claim 3, wherein the fluid locking device comprises:
a fixed pole disposed on the hinge block and configured to be movable toward the hinge pipe;
a pipe external gear formed on an external circumferential surface of the hinge pipe and configured to be engaged with the fixed pole; and
a pole driving bladder elastically deformed by the fluid injected thereinto so that the fixed pole is engaged with the pipe external gear.

11. The seat cushion tilting device of claim 10, further comprising:
a locking control valve connected to the pole driving bladder of the fluid locking device and configured to supply or discharge the fluid to or from the pole driving bladder of the fluid locking device.

12. The seat cushion tilting device of claim 10, further comprising a return spring configured to apply elastic force in a direction allowing the fixed pole to be spaced apart from the pipe external gear.

13. The seat cushion tilting device of claim 2,
wherein a tilting control valve configured to supply or discharge the fluid to or from the tilting bladder is disposed between the fluid supply source and the tilting bladder,
wherein a locking control valve configured to supply or discharge the fluid to or from the fluid locking device is disposed between the fluid supply source and the fluid locking device, and
wherein the tilting control valve and the locking control valve are configured to be controlled by a controller.

14. The seat cushion tilting device of claim 13,
wherein the controller is configured to control, based on an input operation received from a user for adjustment of a tilting angle of a seat cushion, the locking control valve to release a locked state of the fluid locking device so that the tilting bracket is switched to a state in which the tilting bracket is rotatable about the hinge pipe, and to control, after the switching of the tilting bracket, the tilting control valve in response to an operation from the user to supply or discharge the fluid to or from the tilting bladder, and
wherein the controller is configured to control, based on determination that the operation received from the user is completed, the locking control valve to form the locked state of the fluid locking device so that the tilting bracket is restricted from being rotated around the hinge pipe.

15. The seat cushion tilting device of claim 14,
wherein the controller is configured to communicate with a vehicle collision warning system, and
wherein the controller is configured to release the locked state of the fluid locking device based on a vehicle collision possibility determined by the vehicle collision warning system, and to supply the fluid to the tilting bladder to increase the tilting angle of a front side of the seat cushion.
